(19) United States
(12) Patent Application Publication
(10) Pub. No.: US 2026/0114463 A1
(43) Pub. Date: Apr. 30, 2026

(54) COATING LIQUID COMPOSITION, PRODUCTION METHOD THEREFOR, AND LIQUID CONTAINING LOW-TEMPERATURE DAMAGE INHIBITOR

(71) Applicant: Mitsubishi Chemical Corporation, Tokyo (JP)

(72) Inventors: Natsuki HIRA, Omihachiman-shi (JP); Atsushi TAKAKI, Yamato-shi (JP); Daichi NISHIMURA, Osaka (JP)

(73) Assignee: Mitsubishi Chemical Corporation, Tokyo (JP)

(21) Appl. No.: 19/344,728

(22) Filed: Sep. 30, 2025

Related U.S. Application Data
(63) Continuation of application No. PCT/JP2024/013515, filed on Apr. 1, 2024.

(30) Foreign Application Priority Data
Mar. 30, 2023 (JP) 2023-055874
Aug. 25, 2023 (JP) 2023-137420
Mar. 27, 2024 (WO) PCT/JP2024/012487

(51) Int. Cl. A23B 7/08

(52) U.S. Cl. CPC A23B 7/085

(57) ABSTRACT

The present disclosure relates to a coating liquid composition containing a surfactant, wherein the transmittance of light having a wavelength of 875 nm at the time of production is 60% or more as measured under specific conditions using a particle size distribution measuring apparatus for evaluating the dispersibility of multiple samples.

### CROSS-REFERENCE TO RELATED APPLICATIONS

This application is a continuation of International Application PCT/JP2024/013515 filed on Apr. 1, 2024, and claims priority to Japanese application No. 2023-055874 filed on Mar. 30, 2023, Japanese application No. 2023-137420 filed on Aug. 25, 2023 and PCT/JP2024/012487 filed on Mar. 27, 2024, the disclosures of all of which are incorporated herein by reference in their entireties.

### TECHNICAL FIELD

The present invention relates to a coating liquid composition, a method for producing the composition, and a low-temperature damage inhibitor-containing liquid.

### BACKGROUND ART

In recent years, packaging materials that can maintain the freshness of food during distribution or storage, such as modified atmosphere (MA) packaging, have been attracting attention.

For example, technology has been proposed in which a layer having a freshness-preserving effect is provided on a film used to package food, and thereby the freshness of the food is maintained (see Patent Literature 1).

In addition, technology has been proposed in which a quality preservation agent is coated directly onto food such as fruits and vegetables to preserve the freshness of the food (see Patent Literatures 2, 3, and 4).

Patent Literature 5 discloses, as a liquid agent for maintaining the freshness of foods, an exocarp damage inhibitor for fruits and vegetables, the exocarp damage inhibitor containing, as an active ingredient, a surfactant having an HLB of 5 or lower. A lipophilic surfactant used in the invention of Patent Literature 5 is not easily dispersed and dissolved in water, and therefore a method of spraying fruits and vegetables with an emulsion prepared by emulsification using a hydrophilic emulsifier, or a method of adhering a surfactant having an HLB of 5 or less to the surface of fruits or vegetables by immersion is disclosed.

Furthermore, Patent Literature 6 describes an agent for preventing low-temperature damage to fruits and vegetables, the agent containing a sucrose fatty acid ester having a monoester content of 40 wt. % or more.

Moreover, Patent Literature 7 describes an aqueous dispersion of a sucrose fatty acid ester, the aqueous dispersion containing a sucrose fatty acid ester, an anionic surfactant, and water, wherein the anionic surfactant is a fatty acid metal salt, and the content thereof is from 0.1 to 50 wt. % relative to the sucrose fatty acid ester.

### CITATION LIST

### Patent Literature

Patent Literature 1: JP 2001-171058 A
Patent Literature 2: JP 2018-134115 A
Patent Literature 3: JP 2005-530502 T
Patent Literature 4: JP 2018-529627 T
Patent Literature 5: JP 08-56564 A
Patent Literature 6: JP 01-206947 A
Patent Literature 7: JP 2022-100297 A

### SUMMARY

### Technical Problem

In the technology disclosed in Patent Literature 1, since food may come into contact with the packaging film during distribution or storage, the layer having a freshness-preserving effect is also preferably highly safe for the human body. In addition, from the viewpoint of waste, another issue to be addressed is that of reducing the packaging film itself.

The methods disclosed in Patent Literatures 2 and 3 have a short freshness-preservation period and are not necessarily sufficient for exhibiting freshness-preservation performance. Another problem is that the material used is a composition that is not gentle to the human body.

Meanwhile, as disclosed in Patent Literature 4, a method for maintaining the freshness of agricultural products by using a protective coating derived from a monoacylglyceride and covering the agricultural products is known. However, agricultural products come in a variety of shapes and types, and thus it is thought that, depending on the coating method, it may not necessarily be possible to apply a protective coating to the entire surface of an agricultural product.

The liquid agent disclosed in Patent Literature 5 has insufficient liquid stability, and gelation may occur during preparation of the liquid agent or over time. Furthermore, when the liquid agent disclosed in Patent Literature 5 is applied to food such as fruits and vegetables, it takes time to dry the liquid agent, and thus productivity may be poor. In addition, there are cases in which signs of application may be observed, or the surface of the coated food may be whitened, and thus there may be cases in which the appearance of the coating film is poor.

The exocarp damage inhibitor disclosed in Patent Literature 6 for use on fruits and vegetables is not easily dispersed or dissolved in water and is therefore emulsified, but the upper limit of the concentration thereof is 1.0 wt. %, and there is still room for improvement in consideration of the effect on fruits and vegetables.

Patent Literature 7 describes that the sucrose fatty acid ester aqueous dispersion disclosed therein is useful as an additive or coating agent for food, cosmetics, pharmaceuticals, and the like, but there is still room for further optimization for application to fruits and vegetables.

In view of the above problems, the present applicant proposed in the patent application JP 2021-169055 a composition containing a sugar-based surfactant and an aqueous solvent, wherein the main component of the sugar-based surfactant is sugar fatty acid esters, and of 100 mass % of the sugar fatty acid esters, the content of a sugar fatty acid ester having three or less fatty acid ester groups is from 50 to 98 mass %, and the content of a sugar fatty acid ester having five or more fatty acid ester groups is from 2 to 50 mass %.

The composition described in the above application exhibits good liquid stability and can ensure sufficient freshness-preserving performance when applied to food.

Although it is preferable to use, as a raw material of the coating liquid, a sucrose fatty acid ester that is, for example, a surfactant for foods, such a sucrose fatty acid ester does not dissolve in an aqueous solvent and has a dispersion structure as an emulsion, and therefore a state in which the sucrose fatty acid ester is uniformly dispersed in a low-viscosity liquid such as an aqueous solvent is not easily maintained.

Meanwhile, the mechanism of low-temperature damage, which is one of the indicators for evaluating the freshness of agricultural products, has not been elucidated, and even if an agent that suppresses weight loss, ripening, and the like during storage is used, it cannot be presumed that low-temperature damage can be prevented or suppressed.

In contrast, in Patent Literature 6, a sucrose fatty acid ester is used to prevent low-temperature damage of fruits and vegetables, but the concentration when applied to fruits and vegetables is low, and it is considered that there is still room for further examination on the preparation and effectiveness of the low-temperature damage inhibitor.

Accordingly, the present applicants have focused intently on further improving liquid stability for providing both a coating liquid composition that exhibits very high stability and a method for producing the coating liquid composition, and have also focused intently on further improving liquid stability and the effect of suppressing low-temperature damage for providing a low-temperature damage inhibitor-containing liquid having high stability and a high effect thereof.

### Solution to Problem

The present inventors have focused attention on a coating liquid composition containing a surfactant and on a process for producing a low-temperature damage inhibitor-containing liquid that contains a surfactant. That is, the present inventors have discovered that the stability of a coating liquid composition containing a surfactant and of a low-temperature damage inhibitor-containing liquid containing a surfactant can be maintained at an extremely high level by controlling the production conditions.

The inventors have also discovered that when the produced low-temperature damage inhibitor-containing liquid is applied to fruits and vegetables to provide the low-temperature damage inhibitor thereon, an excellent low-temperature damage suppressing effect is exhibited.

The present disclosure has been completed based on the above findings.

That is, the present disclosure provides the following aspects.
[1] A coating liquid composition containing a surfactant, wherein a transmittance of light having a wavelength of 875 nm is 60% or more as measured under conditions described below using a particle size distribution measuring apparatus for evaluating a dispersibility of multiple samples at the time of production, and an amount of change in a transmittance after being left to stand at 20° C. for 18 days relative to the transmittance at the time of production is 10% or less.

### Measurement Conditions

Cell optical path length: 2 mm, liquid amount: 0.4 ml, cell internal cross-sectional area: 16 mm², measurement position: a distance of 120 mm from a rotation center of the particle size distribution measuring apparatus for evaluating the dispersibility of multiple samples, rotation speed: 4000 rpm, rotation time: 30 minutes.
[2] The coating liquid composition according to [1], wherein the surfactant contains a sugar-based surfactant.
[3] The coating liquid composition according to [1] or [2], wherein the surfactant contains a glycerin fatty acid ester.
[4] The coating liquid composition according to [2] or [3], wherein the sugar-based surfactant contains a sugar fatty acid ester.
[5] The coating liquid composition according to any of [1] to [4], wherein a concentration of a nonvolatile component is from 1 to 20 mass %.
[6] The coating liquid composition according to [5], wherein the content of the surfactant in the nonvolatile component is 60 mass % or more.
[7] The coating liquid composition according to any of [1] to [6], wherein a shear viscosity at a shear rate of 1 s⁻¹ is from 0.1 to 900 mPa·s.
[8] The coating liquid composition according to any of [1] to [7], wherein, in differential scanning calorimetry in which a measurement temperature range is set to −80° C. or higher, a ratio of a total exothermic peak area A₃ to a total endothermic peak area A₂ at 0° C. or higher and 80° C. or lower is 50% or less.
[9] A method for applying the coating liquid composition described in any of [1] to [8].
[10] A method for preserving food freshness, the method including using the coating liquid composition described in any of [1] to [8].
[11] A low-temperature damage inhibitor containing a surfactant, wherein a transmittance of light having a wavelength of 875 nm is 60% or more as measured under conditions described below using a particle size distribution measuring apparatus for evaluating a dispersibility of multiple samples at the time of production, and a concentration of a nonvolatile component is 0.5 mass % or more.

### Measurement Conditions

Cell optical path length: 2 mm, liquid amount: 0.4 ml, cell internal cross-sectional area: 16 mm², measurement position: a distance of 120 mm from a rotation center of the particle size distribution measuring apparatus for evaluating the dispersibility of multiple samples, rotation speed: 4000 rpm, rotation time: 30 minutes.
[12] The low-temperature damage inhibitor according to [11], wherein an amount of change in a transmittance after being left to stand at 20° C. for 18 days relative to the transmittance at the time of production is 10% or less.
[13] A method for applying the low-temperature damage inhibitor described in [11] or [12].
[14] A method for inhibiting low-temperature damage to fruits and vegetables, the method including using the low-temperature damage inhibitor described in [11] or [12].
[15] A method for producing a coating liquid composition containing a surfactant, the method including heating to 50 to 90° C., and then cooling to 25° C. within 60 minutes.
[16] The method for producing a coating liquid composition according to [15], wherein the surfactant contains a sugar-based surfactant.
[17] The method for producing a coating liquid composition according to or [16], wherein the surfactant contains a glycerin fatty acid ester.
[18] The method for producing a coating liquid composition according to or [17], wherein the sugar-based surfactant is a sugar fatty acid ester.
[19] The method for producing a coating liquid composition according to any of to [18], wherein a concentration of a nonvolatile component in the coating liquid composition is from 1 to 20 mass %.
[20] The method for producing a coating liquid composition according to [19], wherein a content of the surfactant in the nonvolatile component is 60 mass % or more.

### Advantageous Effects

According to the present disclosure, a coating liquid composition having extremely high stability, a method for producing the coating liquid composition, and a low-temperature damage inhibitor-containing liquid having high stability can be provided.

### DESCRIPTION OF EMBODIMENTS

The present disclosure will be described hereinafter in detail, but the present disclosure is not limited to only the specific embodiments given herein.

### Coating Liquid Composition

The coating liquid composition of the present disclosure is characterized by containing a surfactant and having a transmittance of light having a wavelength of 875 nm of 60% or more as measured using a particle size distribution measuring apparatus (LUMiSizer (registered trademark), available from Nihon Rufuto Co., Ltd.) for evaluating the dispersibility of multiple samples with the measurement position being at a distance of 120 mm from the rotation center of the particle size distribution measuring apparatus for evaluating the dispersibility of multiple samples after the passage of 30 minutes in a centrifugal separator for analysis at a rotation speed of 4000 rpm.

The light having a wavelength of 875 nm is called near-infrared light, and a transmittance of 60% or more of light having the wavelength means that the dispersibility of the surfactant is high. From the above viewpoint, the transmittance of light in the above wavelength range is preferably 65% or more, preferably 70% or more, and preferably 75% or more.

As used herein, the transmittance refers to the transmittance immediately after production of the coating liquid composition.

Moreover, a coating liquid is a liquid that is used to cover the surface of a substance with a coating film or layer formed of a substance different from the substance to be covered.

When a sugar fatty acid ester or a glycerin fatty acid ester described below is used as a surfactant contained in the coating liquid, the coating liquid can be suitably used for food products and fruits and vegetables.

The coating liquid composition of the present disclosure can be used to prevent low-temperature damage. In this case, the coating liquid composition for preventing low-temperature damage can be applied to food such as fruits and vegetables. By coating food such as fruits and vegetables with the coating liquid composition thereof, low-temperature damage to the food can be suppressed.

In the present disclosure, when the coating liquid composition is to be measured, it is assumed that the measurement is carried out on the coating liquid composition that has not undergone precipitation. The expression “has not undergone precipitation” means that after the coating liquid composition is brought into a homogenized state by stirring before sampling, some or all of the coating liquid composition is quickly transferred to a transparent container and allowed to stand at room temperature for 30 minutes, after which the coating liquid composition can be visually observed to confirm that no precipitation has occurred at the bottom. This criterion is also applied to other measurements besides the measurement of the particle size distribution for evaluating the dispersibility of multiple samples.

### Low-Temperature Damage Inhibitor-Containing Liquid

The low-temperature damage inhibitor-containing liquid of the present disclosure is characterized by containing a surfactant and a solvent, and is further characterized in that the concentration of a nonvolatile component is 0.5 mass % or more, and the transmittance of light having a wavelength of 875 nm is 60% or more as measured using a particle size distribution measuring apparatus (LUMiSizer (registered trademark), available from Nihon Rufuto Co., Ltd.) for evaluating the dispersibility of multiple samples at the time of production with the measurement position being at a distance of 120 mm from the rotation center of the particle size distribution measuring apparatus for evaluating the dispersibility of multiple samples after the passage of 30 minutes in a centrifugal separator for analysis at a rotation speed of 4000 rpm. The low-temperature damage inhibitor-containing liquid of the present disclosure may contain the coating liquid composition described above.

Hereinafter, in the present specification, the description of the “coating liquid composition” of the present disclosure is intended to include the “low-temperature damage inhibitor-containing liquid” of the present disclosure in a case in which combinations of configurations are overlapped. That is, the description of the “coating liquid composition” of the present disclosure can also be used for the “low-temperature damage inhibitor-containing liquid” of the present disclosure, and the preferred composition, production method, and usage method may be the same.

The coating liquid composition of the present disclosure exhibits a high level of transmittance after being left to stand for 18 days, and preferably, the rate of change (amount of change) of the transmittance after being left to stand for 18 days at 20° C. relative to the transmittance at the time of production is 10% or less (10% pt or less). The transmittance at the time of production and the transmittance after being left to stand at 20° C. for 18 days are each expressed in terms of a percentage, and thus the difference therebetween is also described in units of % pt. This index indicates that the dispersibility of the surfactant immediately after production is high, and the high dispersibility is maintained even after 18 days. From the above viewpoint, the amount of change in transmittance after being left to stand for 18 days is preferably 8% (8% pt) or less, and preferably 7% (7% pt) or less. The amount of change in transmittance after being left to stand at 20° C. for 18 days relative to the transmittance at the time of production is obtained by subtracting the transmittance at the time of production from the transmittance after being left to stand at 20° C. for 18 days.

A coating liquid composition containing a typical surfactant has a low transmittance value immediately after production, but the transmittance may increase after the passage of 18 days (after being left to stand). This indicates that a dispersion in which precipitation does not occur even when subjected to a centrifugal separation treatment is present immediately after production, and means that the particle size thereof is small. A dispersion having a small particle size has a large surface area and poor stability, and therefore tends to aggregate and settle. An increase in transmittance after the passage of 18 days indicates a reduction in the dispersion having a small particle size. That is, the dispersed state changes during the 18 days of standing, and this means that the degree of dispersion of the surfactant is low.

Meanwhile, when the light transmittance is within the range of the present disclosure, the change in transmittance after the coating liquid composition is left to stand for 18 days is small. That is, the number of microparticles having low stability is small, the change in the state is small, and the state stability of the liquid is high. The amount of change in transmittance can be a negative value, but in consideration of variations in measurements, it can be said that the stability of the liquid is high when the amount of change in transmittance is between −10% pt and +10% pt. Preferably, the amount of change in transmittance is between −8% pt and +8% pt, and is preferably between −7% pt and +7% pt.

Although the stability of the liquid can be partially estimated from the particle size of the dispersion, it is very difficult to evaluate the stability in consideration of scientific properties such as the shape, particle size distribution, and surface potential. However, with the method used in the present disclosure, the stability of the liquid can be evaluated without expressly understanding such dispersion properties.

### Evaluation of Coating Liquid Composition Stability

The stability of the coating liquid composition is evaluated under the following conditions immediately after production and again after being left to stand at 20° C. for 18 days, using the following apparatus.
Apparatus: Dispersion stability analyzer “LUMiSizer (registered trademark)” (available from Nihon Rufuto Co., Ltd.)
Measurement cell: LUM 2mmPA (polyamide) (optical path length: 2 mm)
Rotation speed: 4000 rpm
Measurement temperature: 25° C.
Measurement time: 30 minutes

### Evaluation Criteria

◯: The transmittance at a measurement position of 120 mm is 60% or more, and the change in transmittance between immediately after production and after being left to stand is 10% or less.
x: The transmittance at a measurement position of 120 mm is less than 60%, and the change in transmittance between immediately after production and after being left to stand is more than 10%.

### Surfactant

The coating liquid composition of the present disclosure contains a surfactant. When a surfactant is contained, the coating liquid composition exhibits a high level of wettability, and the coatability on food such as fruits and vegetables to be coated is enhanced. Two or more surfactants may be used in combination.

The surfactant is a substance that exhibits surface activity to lower the surface tension of a solution in which the surfactant is dissolved and is used in practical applications.

The surfactant has a hydrophilic group and a lipophilic group.

Examples of the hydrophilic group include a hydroxyl group, a carboxylate group, a sulfate group, a phosphate group, an amino group, and a quaternary ammonium group. The carboxylate group, the sulfate group, the phosphate group, the amino group, and the quaternary ammonium group may be in the form of a salt. Examples of lipophilic groups include a hydrocarbon group, a fluorine group, and an organosilicon group.

In a case in which a fatty acid is used as a compound for forming a lipophilic group when synthesizing a surfactant, the fatty acid is preferably an edible fat or oil.

The number of carbons of the fatty acid is not particularly limited, but is preferably 12 or more and 22 or less, preferably 12 or more and 18 or less, and preferably 14 or more and 18 or less. When the number of carbons is within the above range, stickiness of the resulting coating film can be suppressed.

The fatty acid may be a saturated or unsaturated fatty acid, but is preferably a saturated fatty acid from the viewpoints of easily forming a solid at normal temperature (from 20 to 25° C.) and suppressing stickiness of the obtained coating film.

More specific examples include lauric acid, myristic acid, pentadecylic acid, palmitic acid, palmitoleic acid, margaric acid, stearic acid, and oleic acid. Among these, lauric acid, myristic acid, palmitic acid, and stearic acid, which are saturated fatty acids having 12 or more and 18 or less carbons, are preferable, and myristic acid, palmitic acid, and stearic acid, which are saturated fatty acids having 14 or more and 18 or less carbons, are more preferable. One type of these saturated fatty acids may be used alone, or two or more types thereof may be used in combination.

All of the fatty acids need not be the same, and 60 mass % or more of the fatty acids constituting the surfactant need only be the above-described suitable constituent fatty acids. From the viewpoint of suppressing stickiness of the resulting coating film, this proportion is preferably 70 mass % or more, preferably 80 mass % or more, and preferably 90 mass % or more. The upper limit thereof is not particularly limited, and need only be 100 mass % or less.

The composition of the fatty acids constituting the surfactant can be measured by isolating the surfactant from the coating liquid composition, forming a derivative therefrom, and analyzing the derivative by gas chromatography.

As the surfactant used in the coating liquid composition of the present disclosure, an ester-type surfactant or an ether-type surfactant is preferable from the viewpoint of biodegradability.

As the ester-type surfactant, a glycerin fatty acid ester or a sugar fatty acid ester is preferable from the viewpoint of being approved as a food additive.

As the ether-type surfactant, an alkyl glycoside is preferable from the viewpoint of being approved as a food additive.

Among these, from the viewpoint of being able to easily adjust hydrophilicity and hydrophobicity, a glycerin fatty acid ester and a sugar fatty acid ester are preferable, and from the viewpoints of high water solubility and the ability to be used by being dissolved in a solvent containing water as a main component, a sugar fatty acid ester is preferable.

Hereinafter, a sugar fatty acid ester and an alkyl glycoside are collectively referred to as sugar-based surfactant.

The HLB of the surfactant is not particularly limited, but from the viewpoint of being able to form a coating film using an aqueous solvent described below, the HLB is preferably 5 or more, preferably 7 or more, and preferably 9 or more. The upper limit of the HLB is usually 20, and is preferably 18 or less.

### Sugar-Based Surfactant

The sugar-based surfactant is a surfactant having a sugar as a hydrophilic group, and examples thereof include a sugar fatty acid ester formed by ester bonding of a sugar and a fatty acid, and an alkyl glycoside formed by glycoside bonding of a sugar and a higher alcohol, and among these, a sugar fatty acid ester is preferable from the viewpoint of film formability.

The sugar-based surfactant preferably has crystallinity from the viewpoint of suppressing stickiness of the obtained coating film and increasing the water vapor barrier property and the oxygen barrier property.

From the viewpoint of suppressing stickiness of the obtained coating film, the sugar-based surfactant preferably contains a component that is solid at normal temperature (from 20 to 25° C.) in an amount of 60 mass % or more, preferably 70 mass % or more, preferably 80 mass % or more, and preferably 90 mass % or more. The sugar-based surfactant may be composed only of a component that is solid at normal temperature (from 20 to 25° C.), and therefore the proportion of the component thereof may be 100 mass % or less.

The HLB of the sugar-based surfactant is not particularly limited, but from the viewpoint of being able to form a coating film using an aqueous solvent described below, the HLB thereof is preferably 5 or more, preferably 7 or more, and preferably 9 or more. The upper limit of the HLB is usually 20, and is preferably 18 or less.

### Sugar Fatty Acid Ester

The sugar fatty acid ester is a compound in which a sugar and a fatty acid are ester-bonded.

The sugar in the sugar fatty acid ester may be any of a monosaccharide, a disaccharide, a trisaccharide, a tetrasaccharide, a polysaccharide, a sugar alcohol, and other oligosaccharides.

Examples of the monosaccharide include pentoses such as ribulose, xylulose, ribose, arabinose, xylose, lyxose, and deoxyribose; and hexoses such as psicose, fructose, sorbose, tagatose, allose, altrose, glucose, mannose, gulose, idose, galactose, talose, fucose, fuculose, and rhamnose.

Examples of the disaccharide include sucrose, lactose, maltose, trehalose, turanose, and cellobiose.

Examples of the trisaccharide include raffinose, melezitose, and maltotriose.

Examples of the tetrasaccharide include acarbose and stachyose.

Examples of the polysaccharide include glycogen, starch, cellulose, dextrin, glucan, fructan, and chitin.

Examples of the sugar alcohol include sorbitol, erythritol, xylitol, maltitol, lactitol, mannitol, and glycerin, and the sugar alcohol may be a condensate of these sugar alcohols.

Examples of other oligosaccharides include fructo-oligosaccharides, galacto-oligosaccharides, mannan oligosaccharides, and lactosucrose.

The constituent fatty acid of the sugar fatty acid ester is preferably an edible oil or fat.

The number of carbons of the constituent fatty acid of the sugar fatty acid ester is not particularly limited, but is preferably 12 or more and 22 or less, preferably 12 or more and 18 or less, and preferably 14 or more and 18 or less. When the number of carbons is within the above range, stickiness of the resulting coating film can be suppressed.

The constituent fatty acid of the sugar fatty acid ester may be a saturated or unsaturated fatty acid, but is preferably a saturated fatty acid from the viewpoints of easily forming a solid at normal temperature (from 20 to 25° C.) and suppressing stickiness of the obtained coating film.

More specific examples include lauric acid, myristic acid, pentadecylic acid, palmitic acid, palmitoleic acid, margaric acid, stearic acid, and oleic acid. Among these, lauric acid, myristic acid, palmitic acid, and stearic acid, which are saturated fatty acids having 12 or more and 18 or less carbons, are preferable, and myristic acid, palmitic acid, and stearic acid, which are saturated fatty acids having 14 or more and 18 or less carbons, are more preferable. One type of these saturated fatty acids may be used alone, or two or more types thereof may be used in combination.

It is not necessary that all the constituent fatty acids of the sugar fatty acid ester be the same, and it is sufficient that 60 mass % or more of the constituent fatty acids in the sugar fatty acid ester be the above-mentioned suitable constituent fatty acids. From the viewpoint of suppressing stickiness of the resulting coating film, this proportion is preferably 70 mass % or more, preferably 80 mass % or more, and preferably 90 mass % or more. The upper limit thereof is not particularly limited, and need only be 100 mass % or less.

The constituent fatty acid composition of the sugar fatty acid ester can be measured by isolating the sugar fatty acid ester from the coating liquid composition, forming a derivative therefrom, and analyzing the derivative by gas chromatography.

The range of the number of fatty acid ester groups of the sugar fatty acid ester varies depending on the number of hydroxyl groups that can form an ester bond in the molecular structure of the sugar serving as the hydrophilic group, and is, for example, from 1 to 8 in the case of a sucrose fatty acid ester and from 1 to 4 in the case of a sorbitan fatty acid ester.

From the viewpoint of being dispersible or soluble in an aqueous solvent, the content of a sugar fatty acid ester (monoester, diester, or triester) having three or less fatty acid ester groups is preferably 50 mass % or more, preferably 60 mass % or more, and preferably 70 mass % or more, per 100 mass % of the total amount of the sugar-based surfactant. The upper limit thereof is not particularly limited, and need only be 100 mass % or less.

From the same viewpoint, the content of a sugar fatty acid ester (hexaester, heptaester, octaester, or higher ester) having six or more fatty acid ester groups is preferably 30 mass % or less, preferably 20 mass % or less, and preferably 10 mass % or less, per 100 mass % of the total amount of the sugar-based surfactant. A sugar fatty acid ester having 6 or more fatty acid ester groups need not be contained, and the content thereof may be 0 mass % or more.

After the sugar fatty acid ester has been isolated from the composition, the content of each number of fatty acid ester groups can be measured in accordance with the method of assay described in Residue Monograph prepared by the meeting of the Joint FAO/WHO Expert Committee on Food Additives (JECFA), 84th meeting 2017 “Sucrose Esters of Fatty Acids” and Prepared at the 71st JECFA (2009) and published in FAO JECFA Monographs 7 (2009) “Sucrose Oligoesters Type I” and “Sucrose Oligoesters Type II”.

### Measurement of Monoesters to Triesters and Tetraesters or Higher Esters

A sample is dissolved in a certain amount of tetrahydrofuran (stabilizer-containing GPC or industrial grade), after which insoluble matter is removed using a 0.5 μm membrane filter, and the solution thereby obtained is used as a measurement sample and subjected to high-performance liquid chromatography under the following conditions. The compositional ratio is obtained by individually calculating the peak area of each of the monoesters to triesters and the combined peak area of the tetraesters or higher esters, and the ratio to the total peak area of all the peaks detected up to 43 minutes is calculated.

The peak area is defined as the area from the start point (rising position) to the end point (falling position) of each peak.

When two or more peaks are adjacent to each other and the start point and the end point therebetween are unclear, the area is calculated by using, as the start point and the end point, the point at which the data between the peaks is the smallest.

### Measurement Conditions: Monoesters to Triesters and Tetraesters or Higher Esters

Apparatus: HLC-8320 GPC detector: differential refractometer (available from Tosoh Corporation)
Column: TSKgel G1000HXL, G2000HXL, G3000HXL, G4000HXL (available from Tosoh Corporation)
Column temperature: 40° C.
Detector temperature: 40° C.
Eluent: Tetrahydrofuran (stabilizer-containing GPC or industrial grade)
Flow rate: 0.8 ml/min
Injection amount: 80 μl
Measurement time: 50 minutes (area ratio is calculated based on all peaks detected up to 43 minutes)

### Measurement of Tetraesters to Octaesters

A sample is dissolved in a certain amount of a mixture of methanol (special grade reagent) and tetrahydrofuran (stabilizer-free HPLC grade) having a ratio of methanol to tetrahydrofuran of 20/80 (vol/vol), after which insoluble matter is removed using a 0.45 μm membrane filter, and the solution thereby obtained is used as a measurement sample and is subjected to high-performance liquid chromatography under the following conditions. The compositional ratio of the tetraesters to octaesters is calculated by individually calculating the peak area of each of the tetraesters to octaesters, calculating the ratio to the total peak area of the tetraesters to octaesters, and then proportionally dividing the area ratio of the tetraesters and higher esters obtained in the above “Measurement of Monoesters to Triesters and Tetraesters or Higher Esters” section by the area ratio of the tetraesters to octaesters.

The peak area is defined as the area from the start point (rising position) to the end point (falling position) of each peak.

When two or more peaks are adjacent to each other and the start point and the end point therebetween are unclear, the area is calculated by using, as the start point and the end point, the point at which the data between the peaks is the smallest.

### Measurement Conditions: Tetraesters to Octaesters

### Apparatuses

Degasser: DGU-20A (available from Shimadzu Corporation)
Pump: LC-20AD (available from Shimadzu Corporation)
Oven: CTO-20A (available from Shimadzu Corporation)
Detector: RID-20A differential refractometer (available from Shimadzu Corporation)
Column: 150 mm×4.6 mm i.d.; ODS-2 (available from GL Sciences Inc.)
Column temperature: 40° C.
Detector temperature: 40° C.
Eluent: Methanol (special grade reagent)/tetrahydrofuran (stabilizer-free HPLC grade)=70/30 to 50/50 (vol/vol)
Flow rate: 0.8 ml/min
Injection amount: 20 μl
Measurement time: 16 minutes

The sugar fatty acid ester is not particularly limited as long as it can be used in food, and examples thereof include sucrose fatty acid esters, sorbitan fatty acid esters, and glucose esters, and among these, sucrose fatty acid esters are preferable from the viewpoint of easy availability.

A single type of the sugar-based surfactant need not be used alone, and two or more types thereof may be used in combination. In a case in which two or more types are used in combination, when the total amount of the sugar-based surfactant is 100 mass %, 60 mass % or more thereof is preferably a sucrose fatty acid ester. This proportion is preferably 70 mass % or more, preferably 80 mass % or more, and preferably 90 mass % or more, from the viewpoints of suppressing stickiness of the resulting coating film and increasing the water vapor barrier property and oxygen barrier property. As the sugar-based surfactant, a sucrose fatty acid ester may be used alone, and therefore the proportion thereof may be 100 mass % or less.

### Glycerin Fatty Acid Ester

The glycerin fatty acid ester is a compound in which glycerin and a fatty acid are ester-bonded.

Examples of the fatty acid constituting the glycerin fatty acid ester are the same as those of the fatty acid constituting the sucrose fatty acid ester, but glycerin fatty acid esters have a small number of hydroxyl groups and are therefore relatively low in hydrophilicity. Thus, the number of carbons of the fatty acid used in the hydrophobic moiety is preferably in a relatively small range. From this viewpoint, the number of carbons of the fatty acid is preferably 4 or more, preferably 6 or more, and preferably 8 or more. The number of carbons of the fatty acid is preferably 24 or less, preferably 22 or less, preferably 20 or less, preferably 18 or less, and preferably 16 or less.

From the viewpoints of dispersibility in an aqueous solvent, viscosity of the composition, and handling ease, the content of the glycerin fatty acid ester (monoester) having one fatty acid ester group is usually 5 mass % or more per 100 mass % of the total amount of the glycerin fatty acid ester. The content thereof is preferably 10 mass % or more, preferably 20 mass % or more, preferably 30 mass % or more, and preferably 40 mass % or more. In this range, the content is preferably 50 mass % or more, more preferably 60 mass % or more, preferably 70 mass % or more, and preferably 80 mass % or more. The upper limit thereof is not particularly limited, and need only be 100 mass % or less.

The content of the glycerin fatty acid ester (diester) having two fatty acid ester groups depends on the content of monoesters and triesters, and is not particularly limited.

From the viewpoints of dispersibility in an aqueous solvent, viscosity of the composition, and handling ease, the content of the glycerin fatty acid ester (triester) having three fatty acid ester groups is preferably 50 mass % or less, preferably 40 mass % or less, preferably 30 mass % or less, preferably 20 mass % or less, and preferably 10 mass % or less, per 100 mass % of the total amount of the glycerin fatty acid ester. The lower limit thereof is not particularly limited, and a glycerin fatty acid ester (triester) having three fatty acid ester groups need not be contained (0 mass %), or as an impurity, a glycerin fatty acid ester (triester) having three fatty acid ester groups may be contained in an amount of less than 1 mass %, or in an amount of 0.5 mass % or more.

From the viewpoints of dispersibility in an aqueous solvent, viscosity of the composition, and handling ease, the total content of the glycerin fatty acid ester (monoester) having one fatty acid ester group and the fatty acid ester (diester) having two fatty acid ester groups is preferably 50 mass % or more, preferably 60 mass % or more, and preferably 70 mass % or more, per 100 mass % of the total amount of the glycerin fatty acid ester. The upper limit thereof is not particularly limited, and need only be 100 mass % or less.

Among this range, the proportion of monoesters when the monoesters and the diesters are totaled is preferably 20 mass % or more, preferably 40 mass % or more, preferably 50 mass % or more, preferably 60 mass % or more, and preferably 80 mass % or more. The upper limit thereof is not particularly limited, and need only be 100 mass % or less.

The type and amount of the fatty acid can be analyzed by column chromatography, gas chromatography, thin-layer chromatography, high-performance liquid chromatography, colorimetric analysis, or the like.

### Mass Proportion

The mass proportion (solid content) of the sucrose fatty acid ester to the total mass of the sucrose fatty acid ester and the glycerin fatty acid ester is preferably 1% or more, preferably 5% or more, preferably 10% or more, and preferably 20% or more. The ratio thereof is also less than 100%. When the mass proportion is within this range, the coatability of the present composition is favorable, and the coating appearance after application to fruits and vegetables is good. From the above viewpoints, the mass proportion of the sucrose fatty acid ester to the glycerin fatty acid ester is preferably from 1/99 to 99/1, preferably from 5/95 to 99/1, preferably from 10/90 to 98/2, preferably in a range from 20/80 to 97/3, and preferably in a range from 20/80 to 80/20.

The coating liquid composition of the present disclosure is such that a coating film formed using the coating liquid composition exhibits the effects of a water vapor barrier property and an oxygen barrier property. The coating liquid composition contains a surfactant, and thus is preferable from the viewpoint of safety when the composition is used for food. The surfactant is as described above. A single type of the surfactant may be used alone, or two or more types thereof may be used in combination.

### Solvent

The coating liquid composition of the present disclosure preferably contains a solvent from the viewpoint of coating efficiency. The solvent contained in the coating liquid composition is preferably an aqueous solvent. The aqueous solvent may be water or a mixed solvent of water and one or more water-soluble organic solvents. Examples of the water-soluble organic solvent include alcohols such as ethanol, isopropanol, ethylene glycol, and glycerin. From the viewpoint of enabling application to food, water is preferred, but from the viewpoints of stability and coatability, an organic solvent such as the above-mentioned alcohol may be contained as a solvent in addition to water.

The content of the water-soluble organic solvent in the aqueous solvent is preferably 30 mass % or less, preferably 20 mass % or less, preferably 10 mass % or less, and preferably 5 mass % or less.

### Additional Component

The coating liquid composition of the present disclosure may contain an additional component as long as the effects of the present disclosure are not impaired. Examples of the additional component include a pH adjuster.

As the pH adjuster, for example, acetic acid, lactic acid, citric acid, ammonia, or the like can be used.

### Concentration of Nonvolatile Components

The concentration of nonvolatile components in the coating liquid composition of the present disclosure is not particularly limited, but is preferably 0.1 mass % or more, preferably 0.5 mass % or more, preferably 1 mass % or more, still even more preferably 1.5 mass % or more, preferably 2 mass % or more, and preferably 3 mass % or more. Meanwhile, the concentration thereof is also preferably 20 mass % or less, preferably 15 mass % or less, preferably 10 mass % or less, preferably 9 mass % or less, and preferably 8 mass % or less. By setting the concentration of nonvolatile components to be within the above-described range, the stability of the dispersion liquid is improved while the surfactant is appropriately dissolved in the solvent, and a uniform coating liquid composition can be obtained, thereby facilitating the formation of a uniform film. In addition, a coating film having a suitable film thickness is easily formed. Meanwhile, when the concentration thereof is high, the distance between the dispersion elements is reduced, which increases the opportunities for contact, and thus the risk of aggregation increases, and the stability of the liquid is likely to decrease.

The “nonvolatile component concentration” in the present disclosure is the concentration of nonvolatile components excluding the solvent contained in the composition, and more specifically, is the concentration of nonvolatile components excluding components that volatilize at normal pressure and a temperature of 105° C. or lower. Alternatively, the nonvolatile component concentration can be calculated by the proportion of nonvolatile components in the blended composition.

### Surfactant Content

The content of the surfactant in the coating liquid composition of the present disclosure is preferably 60 mass % or more, preferably 70 mass % or more, preferably 80 mass % or more, and preferably 90 mass % or more, of the nonvolatile components in the coating liquid composition, with 100 mass % being the upper limit, from the viewpoint of being able to increase the water vapor barrier property and oxygen barrier property of the coating film to be produced, and from the viewpoint of being able to increase the effect of suppressing low-temperature damage to fruits and vegetables to which a low-temperature damage inhibitor-containing liquid is applied to adhere a low-temperature damage inhibitor in a case in which the coating liquid composition is used as the low-temperature damage inhibitor-containing liquid.

Since the coating film formed from the coating liquid composition of the present disclosure is obtained by volatilizing the solvent from the composition, the suitable content of the surfactant in the coating film is also the same as described above. In a case in which the coating liquid composition of the present disclosure is used as a low-temperature damage inhibitor-containing liquid, the low-temperature damage inhibitor of the present disclosure is solidified by an operation such as volatilization of a solvent from the low-temperature damage inhibitor-containing liquid, and thus the suitable content of the surfactant in the low-temperature damage inhibitor is also the same as described above.

### pH of Coating Liquid Composition

From the viewpoint of safe application to food, the pH of the coating liquid composition of the present disclosure is preferably 4 or higher and 10 or lower, and preferably 4 or higher and 8 or lower.

### Shear Viscosity of Coating Liquid Composition

The shear viscosity of the coating liquid composition of the present disclosure as measured under the following conditions is preferably 0.1 (mPa·s) or more, preferably 0.2 (mPa·s) or more, preferably 0.5 (mPa·s) or more, and preferably 1 (mPa·s) or more. The shear viscosity is also preferably 900 (mPa·s) or less, preferably 800 (mPa·s) or less, preferably 700 (mPa·s) or less, and preferably 500 (mPa·s) or less. When the shear viscosity is within the above range, the coating liquid composition can be applied without impairing the appearance of the object to be coated.

### Measurement of Shear Viscosity

The shear viscosity is evaluated using the following apparatus immediately after production of the low-temperature damage inhibitor-containing liquid.
Apparatus: rotational rheometer (model: Kinexus Pro+)
Measurement mode: shear rate dispersion of shear viscosity
Measurement temperature: 25° C.
Plate: cone plate type, diameter of 40 mm, cone angle of 2 degrees
Shear viscosity: The shear viscosity at a shear rate of 1 (s⁻¹) in a measurement in which the shear rate is increased from 0 (s⁻¹) to 1000 (s⁻¹) and then decreased from 1000 (s⁻¹) to 0.1 (s⁻¹)

### Differential Scanning Calorimetry at 0° C. or Higher

In differential scanning calorimetry of the coating liquid composition according to the present disclosure in a measurement temperature range of 0° C. or higher, the ratio of the total area A₁ of endothermic peaks in the temperature range of from 0° C. to 40° C. to the total area A₂ of endothermic peaks in the temperature range of from 0° C. to 80° C. may be 50% or less. The ratio thereof is preferably 40% or less, preferably 30% or less, and preferably 20% or less. The ratio thereof may be 0%. When the ratio thereof is within the above range, the proportion undergoing a phase change of the coating film formed from the coating liquid composition is reduced within a practical temperature range for storing, transporting, and selling fruits and vegetables that are not stored in a frozen state, and phase changes that affect the properties of the coating film do not occur. For example, freshness-preserving functions such as the water vapor barrier property and oxygen barrier property described below can be maintained. The peak area is defined as an area from the start point (rising position) to the end point (falling position) of each peak.

The temperature range for calculating A₁ is preferably 0° C. or higher and 35° C. or lower, preferably 0° C. or higher and 30° C. or lower, and preferably 0° C. or higher and 25° C. or lower. This indicates that the temperature is within the above-described temperature range preferable for practical use.

When the measurement temperature range is set to 0° C. or higher, the characteristics of the coating film can be reflected in the temperature range practical for storing, transporting, and selling fruits and vegetables that are not stored in a frozen state. For example, for a compound having a melting point of less than 0° C., when the measurement temperature range is set to less than 0° C., measurements can be carried out that reflect the behavior of the phase change from a liquid to a solid and behaviors such as the crystallization of a component that is not crystallized and the melting of a solid. However, these behaviors are not exhibited within the practical temperature range described above, and it is difficult to say that the measurements reflect practical behaviors.

As for A₁ and A₂, there may be a case in which a plurality of peaks exist within the respective temperature ranges for calculating the total area, or a case in which only a portion of a peak falls within the temperature range. In such a case, all areas of all peaks that exist within the temperature range are calculated for only the portions that fall within the temperature range. For example, when one broad peak is present from 0 to 50° C., only the portion from 0 to 40° C. is calculated as A₁.

It is thought that the surfactant used in the coating liquid composition of the present disclosure has almost no peak in a temperature range exceeding 80° C., and therefore it is considered that it is not necessary to take into account the range exceeding 80° C. for A₂.

Differential scanning calorimetry with a measurement temperature range of 0° C. or higher is carried out under the following conditions.
Measurement apparatus: differential scanning calorimeter
Measurement method: heat flux method
Temperature: 25° C.→0° C.→100° C.
Temperature increase and decrease rate: 10° C./min
Atmosphere: nitrogen
Sample preparation: The coating liquid composition is placed in an empty aluminum pan so that the dry solid content becomes 1 mg, and the material is left to stand at room temperature to dry. A change in weight of 1% or less from the previous day is confirmed, and a measurement sample is obtained.
Reference: aluminum pan

In a case of a sample in which no peak is observed when heating and cooling at a temperature lower than 0° C., the temperature may be decreased from 25° C. to a temperature lower than 0° C. and then increased to 100° C. for measurements.

### Differential Scanning Calorimetry at −80° C. Or Higher

In differential scanning calorimetry of the coating liquid composition according to the present disclosure in a measurement temperature range of −80° C. or higher, the ratio of the total exothermic peak area A₃ to the total endothermic peak area A₂ in the temperature range of 0° C. or higher and 80° C. or lower may be 50% or less. When the temperature is within the above range, stickiness of the coating film formed from the coating liquid composition and in the temperature range in which fruits and vegetables not stored in a frozen state are stored, transported, and sold is suppressed, and thus the handling properties are improved, and, furthermore, freshness-preserving functions such as the water vapor barrier property and the oxygen barrier property described below can be improved. The peak area is defined as the area from the start point (rising position) to the end point (falling position) of each peak.

The exothermic peak is considered to indicate a behavior of a phase change in which a component that has not become a solid becomes a solid, or a behavior in which a component that has not crystallized crystallizes. Meanwhile, an endothermic peak observed at 0° C. or higher is considered to be a peak resulting from the behavior of a phase change in which all components that are capable of becoming a solid in the coating film formed from the coating liquid composition become a solid, such as, for example, a behavior of melting of a crystallized product obtained by crystallizing all the components that are capable of being crystallized in the coating film. Therefore, it is considered that the ratio of the total exothermic peak area A₃ to the total endothermic peak area A₂ at temperatures 0° C. or higher and 80° C. or lower indicates the ratio of the components that have not been solidified at 0° C. or higher, for example, components that are not crystallized, in the coating film formed from the coating liquid composition. From the viewpoint of enhancing the above effect, this ratio is preferably 40% or less, preferably 30% or less, and preferably 20% or less. Some exothermic peaks observed by the measurement method described below may be observed during heating. This is considered to indicate a behavior of components that are in a supercooled state becoming a solid, such as, for example, becoming crystallized.

As for A₂ and A₃, there may be a case in which a plurality of peaks are present in each temperature range in which the total area is calculated. In such a case, all areas of all peaks that exist within the temperature range are calculated for only the portions that fall within the temperature range. Although unlikely, there is also a possibility that one peak is present in a temperature range that includes 0° C. In such a case, whether the peak area is a part or all of A₂ and A₃ is determined according to whether the peak is an endothermic peak or an exothermic peak. For the surfactant used in the coating liquid composition of the present disclosure, it is thought that there are almost no peaks present in the temperature ranges below −80° C. and above 80° C., and therefore it is thought that there is no need to consider the ranges below −80° C. and above 80° C. for A₂ and A₃.

The differential scanning calorimetry in a measurement temperature range of −80° C. or higher is carried out under the following conditions.
Measurement apparatus: differential scanning calorimeter
Measurement method: heat flux method
Temperature: 25° C.→−80° C.→100° C.
Temperature increase and decrease rate: 10° C./min
Atmosphere: nitrogen
Sample preparation: The coating liquid composition is placed in an empty aluminum pan so that the dry solid content becomes 1 mg, and the material is left to stand at room temperature to dry. A change in weight of 1% or less from the previous day is confirmed, and a measurement sample is obtained.
Reference: aluminum pan

### Method for Producing Coating Liquid Composition

The method for producing a coating liquid composition of the present disclosure is characterized by heating to a temperature from 50 to 90° C., and then cooling to 25° C. within 60 minutes. By rapidly cooling to 25° C. within 60 minutes, the dispersibility of the surfactant in the coating liquid composition at the time of production can be enhanced, and even after long-term storage, settling and aggregation of the surfactant do not occur. From the above viewpoint, the cooling time to 25° C. is preferably within 50 minutes, and preferably within 40 minutes.

The method of rapid cooling is not particularly limited, and examples thereof include a method of cooling in an ice bath, and a method of cooling by exposing to cold air.

After heating to a temperature from 50 to 90° C., the temperature may be maintained for a certain period of time, followed by cooling. The temperature maintenance time is preferably 15 minutes or longer, preferably 20 minutes or longer, and preferably 25 minutes or longer. The time thereof is also preferably 2 hours or less, preferably 1 hour or less, and preferably 45 minutes or less. When the temperature maintenance time is within the above range, the uniformity of the surfactant in the coating liquid composition can be enhanced.

When a plurality of solvents are used, some of the solvents may be added at a predetermined timing. For example, some of the solvents may be added before heating or before cooling after heating.

In addition to the above-described production method, the uniformity of the coating liquid composition can be enhanced by using a composition in which a sugar fatty acid ester and a glycerin fatty acid ester are used in combination.

### Coating Film

The coating film formed from the coating liquid composition of the present disclosure has water vapor barrier property and/or oxygen barrier property. Since the coating film is applied to foods such as vegetables, the coating film is preferably edible in consideration of safety when used for food. A single type of surfactant that is used in the coating liquid composition of the present disclosure may be used alone, or two or more types may be used in combination. The coating liquid composition of the present disclosure contains a surfactant, but may also contain, in combination with the surfactant, a polysaccharide, polyvinyl alcohol, clay, or the like. The content of these materials in the coating film is preferably 60 mass % or more, preferably 70 mass % or more, preferably 80 mass % or more, and still preferably 90 mass % or more, with the upper limit being 100 mass %.

The coating film may be formed by solvent-free coating without a solvent, or may be formed by a composition containing a solvent. In the present disclosure, from the viewpoint of safety when the coating film is used on food, it is preferable to have a coating film formed from a coating agent composition containing a sugar-based surfactant and an aqueous solvent. Providing a coating film formed from such a coating liquid composition suppresses respiration and moisture transpiration of vegetables and the like, and the freshness of vegetables and the like is maintained.

### Low-Temperature Damage Inhibitor

When the coating liquid composition of the present disclosure is used as a low-temperature damage inhibitor-containing liquid, a coating film formed from the coating liquid composition of the present disclosure serves as a low-temperature damage inhibitor.

The low-temperature damage inhibitor of the present disclosure can exhibit an effect of suppressing low-temperature damage. In addition, the low-temperature damage inhibitor of the present disclosure can also simultaneously exhibit a water vapor barrier property and/or an oxygen barrier property. Since the coating liquid composition is applied to fruits and vegetables, the low-temperature damage inhibitor is preferably edible in consideration of safety when used for food. A single type of surfactant contained in the low-temperature damage inhibitor of the present disclosure may be used alone, or two or more types may be used in combination. Moreover, the low-temperature damage inhibitor of the present disclosure contains a surfactant, but may also contain a polysaccharide, a polyvinyl alcohol, clay, or the like in addition to the surfactant. The content of the surfactant in the low-temperature damage inhibitor is preferably 60 mass % or more, preferably 70 mass % or more, preferably 80 mass % or more, and preferably 90 mass % or more, with the upper limit being 100 mass %.

The low-temperature damage inhibitor is conveniently applied to fruits and vegetables in the form of a low-temperature damage inhibitor-containing liquid that contains a solvent. From the viewpoint of safety when used for food, the low-temperature damage inhibitor of the present disclosure is preferably applied particularly by applying, to fruits and vegetables, a low-temperature damage inhibitor-containing liquid that contains a sugar-based surfactant and an aqueous solvent. A low-temperature damage inhibiting effect is exhibited by the application of such a low-temperature damage inhibitor. At the same time, respiration and moisture transpiration of vegetables and the like are suppressed, and the freshness of vegetables and the like is maintained.

### Water Vapor Barrier Property

The water vapor transmission rate at 30° C. and 80% RH per 1 μm of the coating film formed from the coating liquid composition of the present disclosure is preferably 0.1 g/(m²·day·atm) or more, preferably 0.5 g/(m²·day·atm) or more, and still preferably 1.0 g/(m²·day·atm) or more. The water vapor transmission rate thereof is preferably 100 g/(m² day·atm) or less, preferably 80 g/(m²·day·atm) or less, preferably 60 g/(m² day·atm) or less, and particularly preferably 40 g/(m²·day·atm) or less. Even amongst these ranges, the water vapor transmission rate is preferably 20 g/(m²·day·atm) or less, preferably 17 g/(m²·day·atm) or less, and preferably 15 g/(m²·day·atm) or less. When the water vapor transmission rate is within the above range, transpiration from vegetables or fruits can be suppressed, and freshness can be maintained.

The water vapor transmission rate (WVTR) can be measured by a differential pressure method using the water vapor transmission rate measuring apparatus DELTAPERM in accordance with JIS K7129-5. More specifically, the water vapor transmission rate is a value obtained by measuring the water vapor transmission rate when a polyethylene terephthalate film having a thickness of 50 μm is coated with the coating liquid composition under conditions of 30° C. and 80% RH, and then converting the measured value thereof into a transmission rate per 1 μm by the following equation.

$$WVTR per 1 μ m of coating film = \frac{( Coating film thickness ( μ m ) )}{( \frac{1}{( WVTR of PET film with coating film )} - \frac{1}{( WVTR of PET film )} )} \qquad [ Math . 1 ]$$

### Oxygen Barrier Property

The oxygen transmission rate at 25° C. and 50% RH per 1 μm of the coating film formed from the coating liquid composition of the present disclosure is preferably 0.1 cc/(m² day·atm) or more, preferably 0.5 cc/(m²·day·atm) or more, and preferably 1.0 cc/(m²·day·atm) or more. The oxygen transmission rate thereof is preferably 500 cc/(m²·day·atm) or less, preferably 300 cc/(m²·day·atm) or less, preferably 250 cc/(m²·day·atm) or less, and preferably 200 cc/(m² day·atm) or less. Even amongst these ranges, the oxygen transmission rate is preferably 100 cc/(m²·day·atm) or less, preferably 90 cc/(m²·day·atm) or less, and preferably 50 cc/(m² day·atm) or less.

When the oxygen transmission rate is within the above range, aging of vegetables or fruits due to respiration can be suppressed, and freshness can be further maintained.

The oxygen transmission rate (OTR) can be measured by an isobaric method using the oxygen transmission rate measuring apparatus OX-TRAN 2/21 (available from MOCON, Inc.) in accordance with JIS K7126-2. More specifically, the oxygen transmission rate is a value obtained by measuring the oxygen transmission rate when a polyethylene terephthalate film having a thickness of 50 μm is coated with the coating liquid composition under conditions of 25° C. and 50% RH, and then converting the measured value thereof into a transmission rate per 1 μm by the following equation.

$$[ Math . 2 ]$$

$$OTR per 1 μ m of coating film = \frac{( Coating film thickness ( μ m ) )}{( \frac{1}{( OTR of PET film with coating film )} - \frac{1}{( OTR of PET film )} )}$$

### Edibility

The coating film formed from the coating liquid composition of the present disclosure is preferably edible. The term “edible” means that the coating film can be used on food. From the viewpoint of safety, it is preferable to use a compound approved as a food additive in an amount that satisfies the approval thereof, thereby making the coating film edible.

### Average Film Thickness

The average film thickness of the coating film formed from the coating liquid composition of the present disclosure is preferably 0.1 μm or more and 10 μm or less, and preferably 0.5 μm or more and 5 μm or less. When the average film thickness is 0.1 μm or more, the water vapor barrier property and the oxygen barrier property are favorable. When the coating film is used as a low-temperature damage inhibitor, the effect of suppressing low-temperature damage is improved. Meanwhile, when the average film thickness is 10 μm or less, the coating film can be formed in a state in which the texture of the food is maintained.

In the present disclosure, the thickness of the coating film need not be uniform over the entire food.

The average film thickness of the coating film can be determined by removing the coating film from the surface of the food to which the coating film is attached, observing a cross section of the coating film and a peeled portion with an electron microscope, a metallurgical microscope, or the like, measuring the thickness at ten or more randomly selected points, and obtaining an average value from the ten measurements.

### Method for Preserving Food Freshness

A method for preserving food freshness using the coating liquid composition of the present disclosure includes a step of covering a food such as vegetables or fruits with the coating liquid composition.

The step of covering with the coating liquid composition of the present disclosure is not particularly limited, as long as it is a step of covering a food with the coating liquid composition of the present disclosure, and examples thereof include a direct application method such as brush application and curtain coating; an immersion method such as impregnation coating; and a spraying method such as spray coating.

Among these, an immersion method or a spraying method is preferable from the viewpoints of productivity and being able to relatively uniformly coat food having a three-dimensional shape.

The coating liquid composition may be solvent-free as long as it can be applied to food.

### Method for Suppressing Low-Temperature Damage of Fruits and Vegetables

When the coating film formed by the coating liquid composition of the present disclosure is used as a low-temperature damage inhibitor, the method for suppressing low-temperature damage of fruits and vegetables includes a step of applying the low-temperature damage inhibitor to food such as fruits or vegetables.

The same method as the above-described method for preserving food freshness can be used in the step of applying the low-temperature damage inhibitor of the present disclosure.

The coating liquid composition of the present disclosure may be applied to only a part of a food or the like, or to the entirety thereof. From the viewpoint of shortening the drying time of the coating liquid composition and increasing the efficiency of the film forming treatment, the coating liquid composition is preferably applied to a part of the food.

In this case, the application area relative to the surface area of the food is preferably 10% or more, preferably 25% or more, preferably 40% or more, and preferably 50% or more.

A portion of the applied coating liquid composition may be removed. The removal method is not particularly limited, and examples thereof include removal by wind pressure using an air dryer. By removing the excess coating liquid composition on the surface of the food, poor drying of portions where an excessive amount of the coating liquid composition has been applied can be prevented.

An example of the application method is described in “Coating Methods” written by Yuji Harazaki and published by Maki Shoten in 1979.

### Fruits and Vegetables

Examples of the fruits and vegetables that are damaged by low temperatures include kidney beans, okra, pumpkins, cucumbers, watermelons, melons, sweet potatoes, tomatoes, eggplants, bell peppers, avocados, plums, and olives; citrus fruits such as oranges, grapefruits, lemons, hassaku citrus, summer orange, sudachi, and kabosu; bananas, pineapples, passion fruits, papayas, mangoes, and apples.

### Drying

After the coating liquid composition is applied to the food, the coating film may be dried for the purpose of removing the aqueous solvent or the like. Examples of the drying method include static drying, air drying, and heat drying, and from the viewpoint of preserving the freshness of vegetables and the like, a method of drying by leaving the coating film to stand at room temperature (from 20 to 25° C.) or a method of air drying at room temperature is preferable.

### EXAMPLES

Next, the present disclosure will be described in more detail with reference to examples. However, the present disclosure is not limited to the examples described below.

In measurements of the coating liquid composition, measurements were carried out on the premise of a coating liquid composition that had not undergone precipitation. The expression “had not undergone precipitation” means that after the coating liquid composition was brought into a homogenized state by stirring before sampling, some or all of the coating liquid composition was quickly transferred to a transparent container and allowed to stand at room temperature for 30 minutes, after which the coating liquid composition was visually observed to confirm that no precipitation had occurred at the bottom.

### Evaluation of Coating Liquid Composition Stability

Regarding the stability of the coating liquid compositions produced in the Examples and Comparative Examples, the transmittance immediately after production and the transmittance after the coating liquid composition was left to stand at 20° C. for 18 days were evaluated using the following apparatus.

In the following measurement results, the results of the measurement are described as the transmittance.
Apparatus: Dispersion stability analyzer “LUMiSizer” (available from Nihon Rufuto Co., Ltd.)
Measurement cell: LUM 2mmPA (polyamide) (optical path length: 2 mm)
Rotation speed: 4000 rpm
Measurement temperature: 25° C.
Measurement time: 30 minutes

### Evaluation Criteria

◯: The transmittance at a measurement position of 120 mm was 60% or more, and the amount of change in transmittance between immediately after production and after being left to stand was 10% pt or less.

x: The transmittance at a measurement position of 120 mm was less than 60%, and the amount of change in transmittance between immediately after production and after being left to stand was 10% pt or more.

### Viscosity Measurement

The viscosity immediately after production of the coating liquid composition was evaluated using the following apparatus.
Apparatus: rotational rheometer (model: Kinexus Pro+)
Measurement mode: shear rate dispersion of shear viscosity
Measurement temperature: 25° C.
Plate: cone plate type, diameter of 40 mm, cone angle of 2 degrees
Shear viscosity: The shear viscosity at a shear rate of 1 (s⁻¹) in a measurement in which the shear rate is increased from 0 (s⁻¹) to 1000 (s⁻¹) and then decreased from 1000 (s⁻¹) to 0.1 (s⁻¹)

### Differential Scanning Calorimetry at 0° C. or Higher

Differential scanning calorimetry was carried out under the following conditions. When no peak is observed at temperatures lower than 0° C., the temperature may be changed from 25° C. to −80° C. and then to 100° C.
Measurement apparatus: NETZSCH DSC 204F1
Measurement method: heat flux method
Temperature: 25° C.→0° C.→100° C.
Temperature increase and decrease rate: 10° C./min
Atmosphere: nitrogen
Sample preparation: The coating liquid composition was placed in an empty aluminum pan so that the dry solid content was 1 mg, and the material was left to stand at room temperature to dry. A change in weight of 1% or less from the previous day was confirmed, and a measurement sample was obtained.
Reference: aluminum pan

### Differential Scanning Calorimetry at −80° C. or Higher

Differential scanning calorimetry in a measurement temperature range of −80° C. or higher was carried out under the following conditions.
Measurement apparatus: NETZSCH DSC 204F1
Measurement method: heat flux method
Temperature: 25° C.→−80° C.→100° C.
Temperature increase and decrease rate: 10° C./min
Atmosphere: nitrogen
Sample preparation: The coating liquid composition was placed in an empty aluminum pan so that the dry solid content was 1 mg, and the material was left to stand at room temperature to dry. A change in weight of 1% or less from the previous day was confirmed, and a measurement sample was obtained.
Reference: aluminum pan

### Low-Temperature Damage Occurrence Rate

As fruits, tomatoes (variety: Momotaro (registered trademark)) were harvested at the fruit ripening stage, individual tomatoes with blemishes or the like were excluded, and the tomatoes were randomly divided into quantities of 20 for each test. The tomatoes were immersed in a predetermined coating liquid and then dried at room temperature for 60 minutes to thereby prepare tomatoes to which a low-temperature damage inhibitor was applied. Twenty tomatoes were stored at 5° C. and observed on days 7, 14, 21, and 28. Individual tomatoes confirmed to have discoloration of the tomato exocarp, spot-like depressions, and softening of the flesh were counted as low-temperature damaged products, and the quantity thereof was evaluated as a percentage of the total number of 20 tomatoes.

### Coating Appearance

Ten cherry tomatoes were immersed in the low-temperature damage inhibitor-containing liquid immediately after production, and then dried overnight at room temperature, and thereby the low-temperature damage inhibitor was applied. The calyx portion of each tomato was confirmed by the naked eye to determine whether the dried product of the coating liquid had hardened or whitened. Cases in which the coating liquid of four or more cherry tomatoes had hardened or whitened were determined to be failing (x), and all other cases were determined to be passing (◯).

### Evaluation of Freshness Preservation

Avocados were used as a fruit or vegetable product, coating liquids prepared in the respective Examples and Comparative Examples were applied thereto by a dipping method, and the coating appearance, the weight retention rate, and the exocarp color were evaluated.

### Coating Appearance

The coating liquid prepared in each of the Examples and Comparative Examples was applied to the avocados by a dipping method, and appearance defects due to the coating liquid remaining on the exocarp of the avocado after drying were visually evaluated according to the following criteria.

### Evaluation Criteria

A: Portions of appearance defects accounted for less than 5% of the exocarp surface of the avocado.
B: Portions of appearance defects accounted for 5% or more and less than 50% of the exocarp surface of the avocado.
C: Portions of appearance defects accounted for 50% or more and 100% or less of the exocarp surface of the avocado.

### Weight Retention Rate

On the basis of the weight of the avocado before storage (day 0) and the weight of the avocado after storage at 25° C. and 50% RH for 4 days, the weight retention rate after the storage for 4 days ((weight after storage/weight on day 0)×100(%)) was determined.

### Weight Loss Rate

On the basis of the weight of the avocado before storage (day 0) and the weight of the avocado after storage at 25° C. and 50% RH for 4 days, the weight loss rate after the storage for 4 days (100−(weight after storage/weight on day 0)×100(%)) was determined.

### Exocarp Color

As avocados ripen, the color of the exocarp changes from green to dark purple. Since these changes are easily understood from avocados and consumers generally evaluate the freshness of avocados by color, a coating film was formed on the surface of avocados, and the freshness-preserving effect was confirmed by the change in color.

Five avocados were prepared for each example and comparative example, and the change in color was evaluated according to the following criteria. The change in color was evaluated before storage (day 0) and after storage at 25° C. and 50% RH for 4 days according to the following criteria.

### Evaluation Criteria

A: The surfaces of none of the samples (0%) or less than 50% of the samples turned completely dark purple.
B: 50% or more and less than 100% of the samples turned completely dark purple on the surface.
C: The surfaces of all the samples (100%) turned completely dark purple.

### Fruit Hardness

A load (N) was measured when a cylindrical plunger having a diameter of 5 mm was pressed 3 mm into an avocado at a speed of 60 mm/min. Three avocados stored at 25° C. and 50% RH for 4 days were used to measure the fruit hardness. The measurements were taken at three different locations near the equator of each avocado, and the arithmetic mean of the obtained values was taken as the fruit hardness.

The raw materials that were used are as follows.
S-1670: Sucrose stearate, “Ryoto (registered trademark) Sugar Ester S-1670” available from Mitsubishi Chemical Corporation, HLB: 16, monoester to triester content: 97% or more, tetraester to octaester content: less than 3%
S-370: Sucrose stearate, “Ryoto (registered trademark) Sugar Ester S-370” available from Mitsubishi Chemical Corporation, HLB: approximately 3, monoester content: approximately 20%, diester, triester, and polyester content: approximately 80%
S-570: Sucrose stearate, “Ryoto (registered trademark) Sugar Ester S-570” available from Mitsubishi Chemical Corporation, HLB: approximately 5, monoester to triester content: 86% or more
S-1170: Sucrose stearate, “Ryoto (registered trademark) Sugar Ester S-1170” available from Mitsubishi Chemical Corporation, HLB: approximately 11, monoester to triester content: 94% or more
S-1670: Sucrose stearate, “Ryoto (registered trademark) Sugar Ester S-1670” available from Mitsubishi Chemical Corporation, HLB: approximately 16, monoester content: approximately 75%, bound fatty acid purity: approximately 70%
F-110: Sucrose stearate, “DK Ester (registered trademark) F-110” available from DKS Co., Ltd., HLB: 11
M-100: Glycerin monocaprylate, “POEM (registered trademark) M-100” available from Riken Vitamin Co., Ltd., HLB: 7.0
Sodium behenate: NS-7, available from Nitto Chemical Industry Co., Ltd.
Sodium stearate: available from FUJIFILM Wako Pure Chemical Corporation
Sodium laurate: available from FUJIFILM Wako Pure Chemical Corporation
Sodium octanoate: available from FUJIFILM Wako Pure Chemical Corporation

### Example 1

A sucrose fatty acid ester (S-1670) was dispersed in an aqueous solvent composed of ethanol and water at 73° C. for 30 minutes, after which the dispersion was rapidly cooled to 25° C. using ice water, to thereby produce a coating liquid composition. The time required to cool to 25° C. was 30 minutes.

The mass proportions of sucrose fatty acid ester/ethanol/water were May 5, 1990. The stability of the coating liquid composition was evaluated by the above method, and the evaluation results are shown in Table 1.

### Comparative Example 1

A coating liquid composition was produced in the same manner as Example 1 except that the produced coating liquid composition was cooled to 25° C. by air cooling instead of rapid cooling. The time required to cool to 25° C. was 3 hours. The stability of the coating liquid composition was evaluated by the above method, and the evaluation results are shown in Table 1.

### Example 2

A sucrose fatty acid ester (S-1170) was dispersed in an aqueous solvent composed of ethanol and water at 73° C. for 30 minutes, after which the dispersion was rapidly cooled to 25° C. using ice water, to thereby produce a coating liquid composition (low-temperature damage inhibitor). The time required to cool to 25° C. was 30 minutes.

The mass proportions of sucrose fatty acid ester/ethanol/water were May 5, 1990. The coating liquid composition was evaluated by the above method, and the evaluation results are shown in Table 1.

### Example 3

A coating liquid composition was produced in the same manner as Example 2 except that the produced coating liquid composition (low-temperature damage inhibitor) was cooled to 25° C. by air cooling instead of rapid cooling. The time required to cool to 25° C. was 3 hours. In addition, the coating liquid composition excluding ethanol was dispersed at 73° C. for 30 minutes, after which ethanol was added thereto, and then the mixture was cooled, to thereby produce a coating liquid composition. The coating liquid composition was evaluated by the above method, and the evaluation results are shown in Table 1.

### Comparative Example 2

A sucrose fatty acid ester (S-1170) was dispersed in an aqueous solvent composed of ethanol and water at 60° C. for 30 minutes, after which the dispersion was rapidly cooled to 25° C. using ice water, to thereby produce a coating liquid composition (low-temperature damage inhibitor). The time required to cool to 25° C. was 30 minutes.

The mass proportions of sucrose fatty acid ester/ethanol/water were 0.35/0/99.65. The coating liquid composition was evaluated by the above method, and the evaluation results are shown in Table 1.

### Test Example 1

The low-temperature damage occurrence rate and the coating appearance were evaluated by the above method under the same conditions except that the coating liquid composition (low-temperature damage inhibitor) was not applied. The results thereof are shown in Table 1.

TABLE 1

| | | Example | Comparative | Example | Example | Comparative | Test |
|---|---|---|---|---|---|---|---|
| | | 1 | Example 1 | 2 | 3 | Example 2 | Example 1 |
| Surfactant | | S-1670 | S-1670 | S-1170 | S-1170 | S-1170 | — |
| Nonvolatile content | | 5 | 5 | 5 | 5 | 0.35 | — |
| concentration [wt. %] | | | | | | | |
| Cooling method | | Rapid | Air | Rapid | Air | Air | — |
| | | cooling | cooling | cooling | cooling | cooling | |
| Transmittance immediately | | 79 | 35 | 73 | 75 | 92 | — |
| after production [%] | | | | | | | |
| Transmittance after being | | 80 | 55 | 79 | 82 | 91 | — |
| left to stand for 18 days [%] | | | | | | | |
| Amount of change in | | 1 | 20 | 6 | 7 | −1 | — |
| transmittance [% pt] | | | | | | | |
| Determination | | ∘ | x | ∘ | ∘ | ∘ | — |
| Shear viscosity [mPa · s] at | | — | — | 48 | 922 | 4 | — |
| shear rate of 1 (s⁻¹) | | | | | | | |
| Proportion of fruits | 7 days | — | — | 0 | — | 0 | 0 |
| with low- | 14 days | — | — | 0 | — | 35 | 40 |
| temperature damage | 21 days | — | — | 35 | — | 55 | 60 |
| | 28 days | — | — | 50 | — | 70 | 75 |

| | | | | | | |
|---|---|---|---|---|---|---|
| Coating appearance | — | — | ∘ | x | ∘ | — |

The results of Example 1 indicate that the coating liquid composition of the present disclosure produced using rapid cooling as the cooling method exhibits high transmittance immediately after production as well as high transmittance after being left to stand for 18 days, indicating a high level of stability.

In contrast, the coating liquid composition of Comparative Example 1 produced using air cooling as the cooling method exhibits low transmittance immediately after production, and the transmittance after being left to stand for 18 days significantly changes as compared with the transmittance immediately after production. The results indicate that the stability of the coating liquid composition is low.

As described above, the results clearly indicated that according to the present disclosure, a coating liquid composition having high stability can be produced.

The results of Example 2 indicate that the coating liquid composition (low-temperature damage inhibitor) having a viscosity of 900 (mPa·s) or less exhibits a good coating appearance. Meanwhile, in Example 3, the coating liquid composition (low-temperature damage inhibitor) having a viscosity of higher than 900 (mPa·s) caused an unnatural appearance due to coating on some parts of the fruit, such as the calyx of the cherry tomatoes, but did not cause an unnatural appearance on the fruit portion itself. The results of Example 2 indicated that a high-stability coating liquid composition (low-temperature damage inhibitor) that can be applied with good appearance to fine portions such as the calyx of a cherry tomato can be produced. That is, when the viscosity is 900 mPa·s or less, the coating treatment is smooth, and the appearance is also favorable.

The results of Example 2 indicate that the occurrence rate of low-temperature damage is low when a coating liquid composition (low-temperature damage inhibitor) having a nonvolatile component concentration of 0.5 mass % or more is used. In contrast, the results of Comparative Example 2 indicate that when the concentration of nonvolatile components in the low-temperature damage inhibitor-containing liquid is lower than 0.5 mass %, the occurrence rate of low-temperature damage is high, and in comparison with Test Example 1, in which the low-temperature damage inhibitor is not applied, the low-temperature damage suppression effect is about the same, and low-temperature damage cannot be sufficiently suppressed. As described above, the results clearly indicated that a low-temperature damage inhibitor-containing liquid that can effectively suppress low-temperature damage can be produced according to the present disclosure.

### Comparative Example 3

A sucrose fatty acid ester (S-1670) and sodium behenate were dispersed in water at 73° C. for 30 minutes, after which the produced coating liquid composition was cooled to 25° C. in an ice bath. The time required to cool to 25° C. was 30 minutes.

The mass proportions of the sucrose fatty acid ester S-1670/sodium behenate/water were 9.8/0.2/90. The stability of the coating liquid composition was evaluated by the above method, and the evaluation results are shown in Table 2.

### Comparative Example 4

A sucrose fatty acid ester (S-1670) and sodium stearate were dispersed in water at 73° C. for 30 minutes, after which the produced coating liquid composition was cooled to 25° C. in an ice bath. The time required to cool to 25° C. was 30 minutes.

The mass proportions of the sucrose fatty acid ester S-1670/sodium stearate/water were 9.8/0.2/90. The stability of the coating liquid composition was evaluated by the above method, and the evaluation results are shown in Table 2.

### Comparative Example 5

A sucrose fatty acid ester (S-1670) and sodium laurate were dispersed in water at 73° C. for 30 minutes, after which the produced coating liquid composition was cooled to 25° C. in an ice bath. The time required to cool to 25° C. was 30 minutes.

The mass proportions of the sucrose fatty acid ester S-1670/sodium laurate/water were 9.8/0.2/90. The stability of the coating liquid composition was evaluated by the above method, and the evaluation results are shown in Table 2.

### Comparative Example 6

A sucrose fatty acid ester (S-1670) and sodium octanoate were dispersed in water at 73° C. for 30 minutes, after which the produced coating liquid composition was cooled to 25° C. in an ice bath. The time required to cool to 25° C. was 30 minutes.

The mass proportions of the sucrose fatty acid ester S-1670/sodium octanoate/water were 9.8/0.2/90. The stability of the coating liquid composition was evaluated by the above method, and the evaluation results are shown in Table 2.

### Comparative Example 7

A sucrose fatty acid ester (S-1170) and sodium stearate were dispersed in water at 73° C. for 30 minutes, after which the produced coating liquid composition was cooled to 25° C. in an ice bath. The time required to cool to 25° C. was 30 minutes.

The mass proportions of the sucrose fatty acid ester S-1170/sodium stearate/water were Aug. 2, 1990. The stability of the coating liquid composition was evaluated by the above method, and the evaluation results are shown in Table 2.

### Comparative Example 8

A sucrose fatty acid ester (S-370) and sodium stearate were dispersed in water at 73° C. for 30 minutes, after which the produced coating liquid composition was cooled to 25° C. in an ice bath. The time required to cool to 25° C. was 30 minutes.

The mass proportions of the sucrose fatty acid ester S-370/sodium stearate/water were Aug. 2, 1990. The stability of the coating liquid composition was evaluated by the above method, and the evaluation results are shown in Table 2.

The results of Comparative Examples 3 to 8 indicate that when the coating liquid composition has a nonvolatile component content of 10.0 mass %, the transmittance immediately after production, the transmittance after being left to stand for 18 days, or the amount of change in the transmittance from immediately after production to after being left to stand for 18 days is large, and the stability of the coating liquid composition is low.

TABLE 2

| | | | | | |
|---|---|---|---|---|---|
| Comparative | Comparative | Comparative | Comparative | Comparative | Comparative |
| Example 3 | Example 4 | Example 5 | Example 6 | Example 7 | Example 8 |

Composition of coating liquid composition and cooling conditions

| | | | | | | | |
|---|---|---|---|---|---|---|---|
| Nonvolatile | [mass %] | 10.0 | 10.0 | 10.0 | 10.0 | 10.0 | 10.0 |
| content | | | | | | | |
| concentration | | | | | | | |
| S-370 | [mass %] | | | | | | 8.0 |
| S-570 | [mass %] | | | | | | |
| S-1170 | [mass %] | | | | | 8.0 | |
| S-1670 | [mass %] | 9.8 | 9.8 | 9.8 | 9.8 | | |
| M-1695 | [mass %] | | | | | | |
| S-100P | [mass %] | | | | | | |
| M-100 | [mass %] | | | | | | |
| Sodium | [mass %] | 0.2 | | | | | |
| behenate | | | | | | | |
| Sodium | [mass %] | | 0.2 | | | 2.0 | 2.0 |
| stearate | | | | | | | |
| Sodium laurate | [mass %] | | | 0.2 | | | |
| Sodium | [mass %] | | | | 0.2 | | |
| octanoate | | | | | | | |
| Ethanol | [mass %] | | | | | | |
| Ion-exchanged | [mass %] | 90.0 | 90.0 | 90.0 | 90.0 | 90.0 | 90.0 |
| water | | | | | | | |
| Cooling | | Rapid | Rapid | Rapid | Rapid | Rapid | Rapid |
| method | | cooling | cooling | cooling | cooling | cooling | cooling |

Stability evaluation of coating liquid composition

| | | | | | | | |
|---|---|---|---|---|---|---|---|
| Transmittance | [%] | 30 | 26 | 24 | 93 | 38 | 38 |
| immediately | | | | | | | |
| after | | | | | | | |
| production | | | | | | | |
| Transmittance | [%] | 42 | 35 | 94 | 5 | 45 | 34 |
| after being left | | | | | | | |
| to stand for 18 | | | | | | | |
| days | | | | | | | |
| Amount of | [% pt] | 12 | 9 | 70 | −88 | 7 | −4 |
| change in | | | | | | | |
| transmittance | | | | | | | |
| Determination | | x | x | x | x | x | x |

### Example 4

A sucrose fatty acid ester (S-1170) and a glycerin fatty acid ester (M-100) were dispersed in water at 73° C. for 30 minutes, after which the produced coating liquid composition was air cooled to 25° C. The time required to cool to 25° C. was 1 hour. The compositional proportions of the coating liquid composition and the results of evaluation by the above method are shown in Table 3.

In differential scanning calorimetry at temperatures of −80° C. or higher of the coating liquid composition in which S-1170 in Example 3 was changed to F-110, which is an equivalent product, during temperature decrease, one exothermic peak of 17.48 J/g was present in a range from −28° C. to −33° C. with a peak top at −29.7° C., and during temperature increase, an exothermic peak of 19.86 J/g was present in a range from −32° C. to −20° C. with a peak top at −26.0° C. Moreover, an endothermic peak of 59.87 J/g having a peak top at 20.8° C. was present in a range of from 3° C. to 24° C., and an endothermic peak of 15.98 J/g having a peak top at 27.0° C. was present in a range from 24° C. to 32° C. In this case, A₃/A₂ was 49%.

### Example 5

A sucrose fatty acid ester (S-1670) and a glycerin fatty acid ester (M-100) were dispersed in water at 73° C. for 30 minutes, after which the produced coating liquid composition was air cooled to 25° C. The time required to cool to 25° C. was 1 hour. The compositional proportions of the coating liquid composition and the results of evaluation by the above method are shown in Table 3.

In differential scanning calorimetry at temperatures of −80° C. or higher, during temperature decrease, two exothermic peaks were present including an exothermic peak of 4.885 J/g in a range from 2° C. to −1° C. with a peak top at 1.1° C. and an exothermic peak of 32.9 J/g in a range from −29° C. to −32° C. with a peak top at −29.6° C., and during temperature increase, an exothermic peak of 32.07 J/g was present in a range from −27° C. to −25° C. with a peak top at −27.1° C. Moreover, an endothermic peak of 59.91 J/g having a peak top at 20.8° C. was present in a range of from 5° C. to 24° C., and an endothermic peak of 25.2 J/g having a peak top at 27.6° C. was present in a range from 24° C. to 30° C. In this case, A₃/A₂ was 82%.

### Example 6

Sucrose fatty acid esters (S-570 and S-1670) and a glycerin fatty acid ester (M-100) were dispersed in water at 73° C. for 30 minutes, after which the produced coating liquid composition was air cooled to 25° C. The time required to cool to 25° C. was 1 hour. The compositional proportions of the coating liquid composition and the results of evaluation by the above method are shown in Table 3.

In differential scanning calorimetry at temperatures of −80° C. or higher, during temperature decrease, two exothermic peaks were present including an exothermic peak of 4.358 J/g in a range from 2° C. to −2° C. with a peak top at 1.8° C. and an exothermic peak of 30.58 J/g in a range from −29° C. to −32° C. with a peak top at −29.7° C., and during temperature increase, an exothermic peak of 28.11 J/g was present in a range from −29° C. to −24° C. with a peak top at −26.4° C. Moreover, an endothermic peak of 57.56 J/g having a peak top at 21.0° C. was present in a range from 2° C. to 24° C., and an endothermic peak of 23.3 J/g having a peak top at 27.2° C. was present in a range from 24° C. to 30° C. In this case, A3/A2 was 78%.

### Test Example 2

The results obtained by conducting evaluation by the above-described method under the same conditions except that the coating liquid composition was not applied are shown in Table 3.

TABLE 3

| Example | Example | Example | Test |
|---|---|---|---|
| 4 | 5 | 6 | Example 2 |

Composition of coating liquid composition and cooling conditions

| | | | | | |
|---|---|---|---|---|---|
| Solid content concentration | [mass %] | 5.00 | 5.00 | 5.00 | — |
| S-570 | [mass %] | | | 0.05 | — |
| S-1170 | [mass %] | 1.00 | | | — |
| S-1670 | [mass %] | | 0.25 | 0.45 | — |
| M-100 | [mass %] | 4.00 | 4.75 | 4.50 | — |
| Ethanol | [mass %] | | | | — |
| Ion-exchanged water | [mass %] | 95.00 | 95.00 | 95.00 | — |
| Cooling method | | Slow | Slow | Slow | |
| | | cooling | cooling | cooling | |

Evaluation of coating liquid

| | | | | | |
|---|---|---|---|---|---|
| Transmittance immediately | [%] | 91 | 92 | 92 | — |
| after production | | | | | |
| Transmittance after being left | [%] | 87 | 91 | 91 | — |
| to stand for 18 days | | | | | |
| Amount of change in | [% pt] | −4 | −1 | −1 | — |
| transmittance | | | | | |
| Determination | | ◯ | ◯ | ◯ | — |
| Shear viscosity at shear rate of | (mPa · s) | 3099 | 3 | 332 | — |
| 1 (s⁻¹) | | | | | |
| Differential scanning | [%] | 49.2 | 82.1 | 78.0 | — |
| calorimetry results at −80° C. or | | | | | |
| higher | | | | | |

Freshness-preserving effect on fruits and vegetables

| Coating appearance | Avocado | | B | A | A | — |
|---|---|---|---|---|---|---|
| Weight retention rate | 4 days | [%] | 96.3 | 96.2 | 96.3 | 94.7 |
| Weight loss rate | 4 days | [%] | 3.7 | 3.8 | 3.7 | 5.3 |
| Exocarp color | 4 days | | A | B | A | C |
| Fruit hardness | 4 days | [N] | 32 | 6 | 8 | 5 |

From the results shown in Table 3, it was found that the coating liquid composition of the present disclosure exhibits high stability. It was also found that the coating liquid compositions of Examples 5 and 6 can be stably subjected to a coating treatment and provides a good coating appearance. In addition, as compared to Test Example 2 in which the coating liquid composition was not applied, the avocados coated with the coating liquid composition of the present disclosure showed better results for the weight retention rate, exocarp color, and fruit hardness after storage for 4 days. That is, from the results of Examples 4 to 6 and Test Example 2, it was found that even when a sugar fatty acid ester and a glycerin fatty acid ester were mixed and used, the stability of the coating liquid composition was high, and the freshness of the avocados could be sufficiently maintained.

It was also found that a smaller ratio of A₃/A₂ obtained from the differential scanning calorimetry results at −80° C. or higher provides a higher freshness preservation effect. In Example 5, in which A₃/A₂ was 82.1%, weight loss, change in exocarp color, and fruit softening were suppressed as compared with Test Example 2, in which no coating treatment was carried out. Meanwhile, in Example 6, in which A₃/A₂ was 78.0%, change in exocarp color and fruit softening were further suppressed, and in Example 4, in which A₃/A₂ was 49.2%, change in exocarp color and fruit softening were further suppressed. In differential scanning calorimetry, when the liquid component changes to a solid component as the temperature is changed, an exothermic peak appears, and therefore the ratio of the exothermic peak to the endothermic peak is considered to be one aspect that represents the amount of liquid component. The film formed on the fruit surface inhibits the permeation of oxygen gas and water vapor, and as a result, weight loss and the progression of ripening are suppressed. When the amount of liquid component in the substance constituting the film component increases, the permeation amount of the gas component also increases. Therefore, from the viewpoint of freshness preservation, it is considered that a smaller ratio of the exothermic peak to the endothermic peak, the ratio thereof representing the liquid component, is more desirable.

From the above, it was demonstrated that the coating liquid composition of the present disclosure can be particularly suitably used on fruits and vegetables.

### INDUSTRIAL APPLICABILITY

According to the present disclosure, when the cooling method is simply changed from air cooling to rapid cooling, the dispersibility of the coating liquid composition can be remarkably enhanced, and the dispersibility is maintained over a long period of time. Therefore, the present disclosure can be used as a composition for coating food.

Furthermore, according to the present disclosure, a coating liquid composition (low-temperature damage inhibitor) that exhibits a significant effect of suppressing low-temperature damage when applied to fruits and vegetables can be obtained. Therefore, the present disclosure can be used as a low-temperature damage inhibitor-containing liquid for fruits and vegetables, and is technology of significant industrial value.

1. A coating liquid composition comprising a surfactant, wherein
a transmittance of light having a wavelength of 875 nm is 60% or more as measured by a method of measurement conditions described below using a particle size distribution measuring apparatus for evaluating a dispersibility of multiple samples at the time of production, and
wherein the method of measurement conditions comprises using a cell optical path length of 2 mm, a liquid amount of 0.4 ml, a cell internal cross-sectional area of 16 mm², a measurement position at a distance of 120 mm from a rotation center of the particle size distribution measuring apparatus for evaluating the dispersibility of multiple samples, a rotation speed of 4000 rpm, and rotation time of 30 minutes.

2. The coating liquid composition according to claim 1, wherein an amount of change in a transmittance after being left to stand at 20° C. for 18 days relative to the transmittance at the time of production is 10% pt or less.

3. The coating liquid composition according to claim 1, wherein the surfactant contains a sugar-based surfactant.

4. The coating liquid composition according to claim 1, wherein the surfactant contains a glycerin fatty acid ester.

5. The coating liquid composition according to claim 2, wherein the sugar-based surfactant contains a sugar fatty acid ester.

6. The coating liquid composition according to claim 1, wherein a concentration of a nonvolatile component in the coating liquid is from 1 to 20 mass %.

7. The coating liquid composition according to claim 6, wherein a content of the surfactant in the nonvolatile component is 60 mass % or more.

8. The coating liquid composition according to claim 1, wherein a shear viscosity at a shear rate of 1 s⁻¹ is from 0.1 to 900 mPa·s.

9. The coating liquid composition according to claim 1, wherein, in differential scanning calorimetry in which a measurement temperature range is set to −80° C. or higher, a ratio of a total exothermic peak area A₃ to a total endothermic peak area A₂ at 0° C. or higher and 80° C. or lower is 50% or less.

10. A method for preserving food freshness, the method comprising applying the coating liquid composition according to claim 1.

11. A method for preserving food freshness, the method comprising using the coating liquid composition according to claim 1.

12. The coating liquid composition according to claim 1, wherein the coating liquid composition inhibits a damage of a product to which the coating liquid is applied, and a concentration of a nonvolatile component in the coating liquid is 0.5 mass % or more.

13. The coating liquid composition according to claim 12, wherein an amount of change in a transmittance after being left to stand at 20° C. for 18 days relative to the transmittance at the time of production is 10% or less.

14. A method for inhibiting low-temperature damage to fruits and vegetables, the method comprising using or applying the coating liquid composition according to claim 12.

15. A method for producing a coating liquid composition containing a surfactant, the method comprising heating a liquid containing the surfactant to 50 to 90° C., and then cooling to 25° C. within 60 minutes.

16. The method for producing a coating liquid composition according to claim 15, wherein the surfactant contains a sugar-based surfactant.

17. The method for producing a coating liquid composition according to claim 15, wherein the surfactant contains a glycerin fatty acid ester.

18. The method for producing a coating liquid composition according to claim 16, wherein the sugar-based surfactant is a sugar fatty acid ester.

19. The method for producing a coating liquid composition according to claim 15, wherein a concentration of a nonvolatile component in the coating liquid composition is from 1 to 20 mass %.

20. The method for producing a coating liquid composition according to claim 19, wherein a content of the surfactant in the nonvolatile component is 60 mass % or more.
